(19) United States
(12) Patent Application Publication
(10) Pub. No.: US 2006/0012284 A1
(43) Pub. Date: Jan. 19, 2006

(54) Strontium silicate-based phosphor and method thereof

(75) Inventors: Chang Hae Kim, Daejeon (KR); Joung Kyu Park, Daejeon (KR); Hee Dong Park, Kyunggi-do (KR); Mi Ae Lim, Chungju Choongchungbook-do (KR)

Correspondence Address: MORGAN LEWIS & BOCKIUS LLP, 1111 PENNSYLVANIA AVENUE NW, WASHINGTON, DC, 20004, US

(73) Assignee: Korea Research Institute of Chemical Technology, Daejeon (KR)

(21) Appl. No.: 10/532,095

(22) PCT Filed: Jan. 29, 2004
(86) PCT No.: PCT/KR04/00153

§ 371 Date: Apr. 21, 2005

(30) Foreign Application Priority Data
Jan. 29, 2003 (KR) 10-2003-0005976

(51) Int. Cl. H01J 1/62

(52) U.S. Cl. 313/487; 313/512

(57) ABSTRACT

Disclosed is a strontium silicate-based phosphor and fabrication method thereof, which is applied to a long wavelength ultraviolet LED, an active luminous LCD, etc., to enable an improvement in the color purity and to enhance the luminous efficiency. The strontium silicate-based phosphor is expressed by a chemical formula: Sr₂₋ₓSiO₄: Eu²⁺ wherein x is 0.001≦x≦1.

### TECHNICAL FIELD

The present invention relates to a strontium silicate-based phosphor, and more particularly, to a strontium silicate-based phosphor having a very high luminous efficiency as applied to a light emitting diode (LED) or an active luminous LCD by adding europium oxide (Eu₂O₃) as an activator to a base material of strontium silicate, mixing the two components, drying and performing a heat treatment the mixed two components under a specific condition.

### BACKGROUND ART

In general, to fabricate LEDs of blue, green, red and the like, it is required to first fabricate different substrates, such as InGaN substrate, GaN substrate, GaAs substrate, ZnO substrate. This requirement needs to use different semiconductor thin films, which causes the fabrication costs and unit price to be increased. Accordingly, if these LEDs can be fabricated using an identical semiconductor thin film, their process is simplified, so that fabrication costs and investment costs can be remarkably reduced. In the meanwhile, a white LED is gaining the popularity as the back light for the LCD of a lighting device, a notebook computer, a handheld terminal and the like.

As a method for fabricating the white LED, there is a trial where a phosphor using ultraviolet rays around 470 nm as the excitation source is further coated on an InGaN-based LED. For instance, the white LED is fabricated by coating a YAG:Ce (cerium) phosphor emitting a yellow light (wavelength: 560 nm) on a blue InGaN-based LED.

However, since the blue LED emits a blue light of which emission peak is 450-470 nm, it is improper in realizing the white LED employing YAG:Ce phosphor. In other words, the excitation source of the blue LED causes the luminous efficiency of the yellow light of the YAG:Ce phosphor to be lowered.

To solve the aforementioned drawbacks, it is strongly requested to introduce a new material capable of realizing yellow light instead of the YAG:Ce phosphor.

### DISCLOSURE OF THE INVENTION

Accordingly, the present invention has been made to substantially obviate one or more of the problems due to limitations and disadvantages of the related art.

An object of the present invention is to provide a strontium silicate-based phosphor having a wide wavelength spectrum and a main peak widely varied and fabrication method thereof.

To achieve these and other advantages and in accordance with the purpose of the present invention, as embodied and broadly described, there is provided a strontium silicate-based phosphor expressed by the following chemical formula: Sr₂₋ₓSiO₄: Eu²⁺ₓ where x is 0.001≦x≦1.

According to another aspect of the present invention, there is provided a method for fabricating a strontium silicate-based phosphor, the method comprising the steps of: forming a mixture where strontium carbonate (SrCO₃), silica (SiO₂), and europium oxide (Eu₂O₃) are mixed; drying the mixture; and performing a heat treatment of the dried mixture in a reducing atmosphere.

According to a further aspect of the present invention, there is provided a white LED chip comprising: an LED; and a strontium silicate-based phosphor, which is excited by a light emitted from the LED and expressed by the following chemical: Sr₂₋ₓSiO₄: EU²⁺ₓ where x is 0.001≦x≦1.

According to the present invention, there can be obtained a yellow phosphor showing a wide wavelength spectrum and having a main peak that is easily movable depending on the concentration of europium. Accordingly, when the yellow phosphor of present invention is applied in the long wavelength LED and the active luminous LCD, the color purity can be improved and the luminous efficiency can be enhanced.

### BRIEF DESCRIPTION OF THE DRAWINGS

Other features and advantages of the invention will be apparent from the following detailed description and the accompanying drawings, in which:

FIG. 1 is photoluminescence emission spectra of the strontium silicate-based phosphor of present invention under the 405 nm excitation wavelength.

FIG. 2 is a schematic sectional view of the LED to which the strontium silicate-based phosphor of present invention is applied.

FIG. 3 is the relative emmission spectra of a white-emitting InGaN-based YAG:Ce LED and GaN-based Sr₂₋ₓSiO₄: EU²⁺ₓ LED.

### BEST MODE FOR CARRYING OUT THE INVENTION

Hereinafter, preferred embodiments of the present invention will be described in detail with reference to accompanying drawings. It will be apparent to those skilled in the art that various modifications and variations can be made therein without departing from the spirit and scope of the invention. Thus, it is intended that the present invention cover the modifications and variations of this invention that come within the scope of the appended claims and their equivalents.

Hereinafter, a concrete embodiment on a fabrication method of a strontium silicate-based phosphor according to the spirit of the present invention will be described.

First, strontium carbonate (SrCO₃), silica (SiO₂), and europium oxide (Eu₂O₃) are weighed and are mixed with a solvent.

In detail, the europium oxide (Eu₂O₃) used for doping the base material is added by a molar ratio of 0.001-1 with respect to the amount of the strontium constituting the base material of the strontium silicate. More preferably, the molar ratio of the europium oxide (Eu₂O₃) is 0.01-0.3 with respect to the content of the strontium. This is because the europium oxide (Eu₂O₃) molar ratio less than 0.001 is insufficient amount in functioning as an activator and the europium oxide (Eu₂O₃) molar ratio more than 1 causes the luminance to be lowered due to concentration quenching phenomenon.

After that, the mixture is dried in an oven. At this time, the drying temperature is 100-150° C. and the drying time is 1-24 hours.

After that, the dried mixture is loaded into a high purity aluminum tube and is heat-treated in a reducing atmosphere of a hydrogen-mixed gas in an electric furnace. If the heat treatment temperature is below 800° C., strontium silicate crystal is not completely created and thereby luminous efficiency is reduced, whereas if the temperature is beyond 1500° C., lowering in the luminance is caused due to high response. Accordingly, the heat treatment temperature is set in a range of 800˜1500° C. for 1˜48 hours.

In detail, the hydrogen-mixed gas uses a nitrogen gas containing 2-25% by weight of hydrogen so as to make a reducing environment.

### EXPERIMENTAL EXAMPLE

In the present experiment, to experiment the embodiment concretely, acetone is used as the solvent used for weighing and mixing strontium carbonate (SrCO₃), silica (SiO₂), and europium oxide (Eu₂O₃), and then ball milling or agate mortar is used as a mixer of the solvent and the components of strontium carbonate (SrCO₃), silica (SiO₂), and europium oxide (Eu₂O₃).

Also, the europium oxide (Eu₂O₃) used for doping the base material was used by a molar ratio of 0.005, 0.03, 0.05 and 0.1 with respect to the amount of the strontium constituting the base material of the strontium silicate. Also, the drying temperature in the oven was 120° C., the drying time was 24 hours, the heat treatment temperature was 1,350° C., and the heat treatment time was 48 hours.

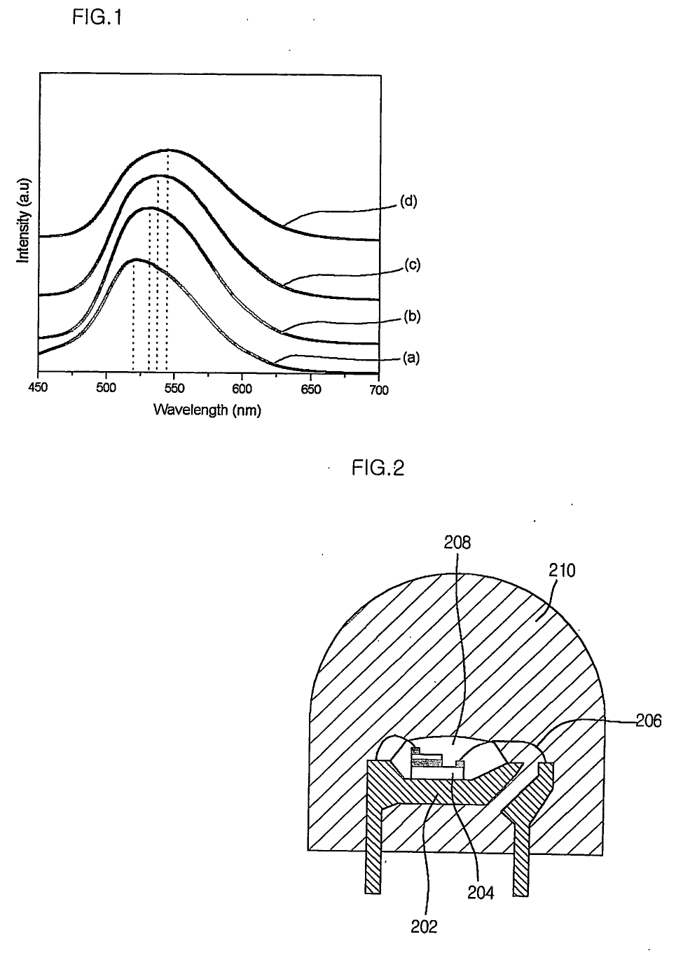

FIG. 1 shows the variation of photoluminescence spectra obtained by exciting a strontium silicate-based phosphor of present invention using an ultraviolet of 405 nm. In FIG. 1, (a), (b), (c) and (d) respectively correspond to 0.005, 0.03, 0.05 and 0.1 molar ratio europium oxide (Eu₂O₃) with respect to the strontium constituting the base material of the strontium silicate.

As can be seen from FIG. 1, a strontium silicate-based phosphor according to the experiment shows a wide wavelength spectrum with a wavelength ranged from 450 nm to 650 nm. As the concentration of the europium increases, the main peak corresponding to a maximum value of the luminous spectrum intensity increases from 520 nm toward 550 nm. Also, it is seen that the spectrum has a relatively wide yellow light range.

By the above experiment, it is known that the strontium silicate-based phosphor shows a relatively wide wavelength spectrum. And, the main peak is varied with the concentration of the europium. Accordingly, when the above strontium silicate-based phosphor is applied to a long wavelength ultraviolet LED and an active luminous LCD as the yellow phosphor, it shows a very high efficiency.

Meanwhile, the present invention is not limited only to the aforementioned drying condition and heat treatment condition. In other words, in case the drying temperature is changed to a range of 110-130° C., the drying time is changed to a range of 8-12 hours, the heat treatment temperature is changed to a range of 1200-1400° C., and the heat treatment time is changed to a range of 2-5 hours, similar results can be obtained.

Hereinafter, the effects of the present invention will be described by comparing the experimental examples in which the strontium silicate-based phosphor is applied to a LED chip with the comparative examples in which the conventional YAG phosphor is applied to a LED chip.

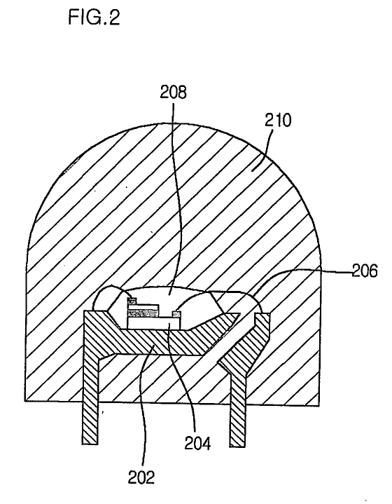

FIG. 2 shows a structure of a long wavelength ultraviolet white LED to which the spirit of the invention is applied.

Referring to FIG. 2, a LED chip according to the spirit of the present invention is configured to include a reflection cup 202, a GaN-based LED 204 placed on the reflection cup 202, a phosphor 208, which is excited by a light emitted from the LED 204, an electrode line 206 connected to the LED 204, and an exterior material 210 for molding and sealing the surrounding of the LED using a decolored or a colored transparent resin.

In detail, the GaN-based LED 204 is connected with an external power through the electrode line 206. The phosphor 208 excited by the light emitted from the LED 204 is formed to cover the LED 204. The phosphor 208 and its surrounding are molded and sealed by the exterior material of the decolored or a colored transparent resin. By the above construction, the long wavelength ultraviolet white LED is formed. Herein, the transparent resin uses epoxy or silicon resin.

Also, the phosphor 208 is formed on an outer surface of the LED 204. By doing so, the light emitted from the LED 204 serves as the excitation light of the phosphor 208.

Here, the GaN-based LED 204 emits an ultraviolet of 405 nm, and the phosphor 208 excited by the LED 204 uses the strontium silicate-based phosphor of present invention.

Next, the long wavelength ultraviolet white LED chip according to the experiment example and the LED chip according to the related art are compared. The LED chip used as the comparative example is a long wavelength ultraviolet LED chip using YAG:Ce yellow phosphor in which YAG phosphor and InGaN chip having the wavelength of 460 nm are used.

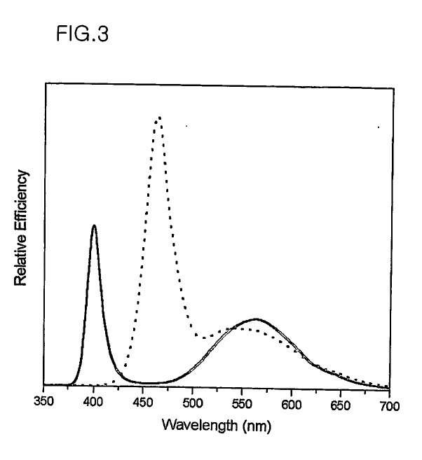

FIG. 3 is a graph comparing a white LED chip fabricated by using the strontium silicate-based phosphor (Sr₂SiO₄:Eu) of present invention with a conventional LED chip using the conventional InGaN chip. In the graph of FIG. 3, the solid line indicates the spectrum of the white LED chip fabricated by using strontium silicate-based phosphor (Sr₂SiO₄:Eu) of present invention, and the dotted line indicates the spectrum of the LED chip fabricated by using the conventional InGaN chip.

Referring to FIG. 3, the white LED chip fabricated using the strontium silicate-based phosphor of present invention shows the spectrum of a wide wavelength band of 450-650 nm, while the comparative example shows the spectrum of a narrow wavelength band of 450-470 nm, and shows that the main peak is formed in a narrow range.

Accordingly, by using the strontium silicate-based phosphor according to the present invention, color purity can be improved. Also, when the strontium silicate-based phosphor of present invention is employed in the long wavelength ultraviolet LED and the active luminous LCD, it can be used as a high efficiency yellow application material.

### INDUSTRIAL APPLICABILITY

As described previously, according to the inventive strontium silicate-based phosphor and fabrication method thereof, the phosphor having a wide wavelength spectrum, and of which main peak is varied in a wide range by varying the concentration of the europium can be obtained. Especially, since the main peak is widely varied, the color purity is improved so that the phosphor of present invention can be applied to a high efficiency yellow phosphor.

Also, when the phosphor of present invention is employed in the long wavelength ultraviolet LED and the active luminous LCD, it can have a very high luminous efficiency.

1. A strontium silicate-based phosphor expressed by the following chemical formula 1:
Sr₂₋ₓSiO₄:Eu²⁺ₓ Chemical formula 1
where x is 0.001≦x≦1.

2. A method for fabricating a strontium silicate-based phosphor, the method comprising the steps of:
forming a mixture where strontium carbonate (SrCO₃), silica (SiO₂), and europium oxide (Eu₂O₃) are mixed;
drying the mixture; and
performing a heat treatment of the dried mixture in a reducing atmosphere to form Sr₂₋ₓSiO₄:Eu²⁺ₓ
where x is 0.001≦x≦1.

3. The method of claim 2, wherein the step of forming the mixture comprising the steps of:
weighing the respective components of the mixture; and
mixing the respective components with a solvent to form the mixture.

4. The method of claim 2, wherein the drying step is performed at a temperature range of 100-150° C.

5. The method of claim 2, wherein the drying step is performed for a time range of 1-24 hours.

6. The method of claim 2, wherein the drying step is performed at a temperature range of 100-150° C. for a time range of 1-24 hours.

7. The method of claim 2, wherein the drying step is performed using an oven.

8. The method of claim 2, wherein the heat treatment is performed at a temperature range of 800-1500° C.

9. The method of claim 2, wherein the heat treatment is performed for a time range of 1-48 hours.

10. The method of claim 2, wherein the heat treatment is performed at a temperature range of 800-1500° C. for a time range of 1-48 hours.

11. The method of claim 2, wherein the drying step is performed at a temperature range of 110-130° C. for a time range of 8-12 hours, and the heat treatment is performed at a temperature range of 1200-1400° C. for a time range of 2-5 hours.

12. The method of claim 2, wherein the heat treatment is performed in the reducing atmosphere made by a hydrogen-mixed gas.

13. The method of claim 2, wherein the heat treatment is performed in the reducing atmosphere of a nitrogen gas containing 2-25% by weight of hydrogen gas.

14. A white LED chip comprising:
an LED; and
a strontium silicate-based phosphor, which is excited by a light emitted from the LED and expressed by the following chemical formula 1:
Sr₂₋ₓSiO₄:Eu²⁺ₓ Chemical formula 1
where x is 0.001≦x≦1.

15. The white LED of claim 14, wherein the light emitted from the phosphor has a wavelength band of 450-650 nm.

16. The white LED of claim 14, wherein the LED is placed on a reflection cup by which the emitted light is reflected.

17. The white LED of claim 14, wherein the LED for exciting the phosphor is a blue LED.

18. The white LED of claim 14, wherein the LED and the phosphor are molded by a transparent resin.
